(19) United States
(12) Patent Application Publication
(10) Pub. No.: US 2006/0085270 A1
(43) Pub. Date: Apr. 20, 2006

(54) Process and system for providing information to customers at point of sale

(75) Inventor: John Ruckart, Atlanta, GA (US)

Correspondence Address: Merchant & Gould P.C., P.O. Box 2903, Minneapolis, MN, 55402-0903, US

(73) Assignee: BellSouth Intellectual Property Corporation

(21) Appl. No.: 11/271,582

(22) Filed: Nov. 10, 2005

Related U.S. Application Data
(63) Continuation-in-part of application No. 10/015,250, filed on Dec. 12, 2001.

(51) Int. Cl. G06Q 20/00; G06Q 30/00

(52) U.S. Cl. 705/21; 705/16; 705/26

(57) ABSTRACT

Customers at a point of sale are provided with offers for goods and services, based on past transactions for that customer. Transaction histories are collected for customers, and customers are classified according to likely interest in future purchases based on previous transactions. When the customer makes a current transaction, that customer may receive offers for additional goods or services based on transaction history. The offers are presented to the customer at a point-of-sale terminal for the current transaction, by printing on a receipt for the current transaction or by displaying on a visual display.

### CROSS-REFERENCE TO RELATED APPLICATION

This is a continuation-in-part of application Ser. No. 10/015,250 filed Dec. 12, 2001.

### FIELD OF THE INVENTION

The present invention relates in general to methods and systems for communicating with customers. More specifically, the present invention relates to communicating with customers in proximity to a point of sale.

### BACKGROUND OF THE INVENTION

Conveying information to customers is often difficult due to the media overload experienced in the market place. Customers are inundated with information, particularly marketing messages and advertisements. This volume of information often begins with advertising messages before the customer enters a store, and continues in the store with product displays and suggestions by sales persons. A customer purchasing particular items may be considered a good prospect for related goods or services, but many customers deliberately or subconsciously disregard sales displays and the blandishments of sales persons. Moreover, in-store displays are often relatively static and lack focus or relevance to the purchasing history of any specific customer. The last persons having an opportunity for direct interaction with a customer in a retail environment usually is a check-out clerk or point-of-sale terminal operator. Although those persons may be trained to offer further goods or services, e.g., service contracts for goods currently purchased, they have limited time to make any such offer and in any case the offer is not specific to the particular customer.

### SUMMARY OF THE INVENTION

Stated in general terms, a process according to the present invention gathers information about past purchases by particular customers and uses that information to suggest other goods or services of possible interest to the customer. The information may be gathered from point-of-sale terminals based on transactions by particular customers and stored at a database maintained by the seller or by a third party. The gathered information is used to develop a profile of customer transactions and to correlate those transactions with purchases of related goods or services acquired by other customers having the same or similar profiles. The correlation may be used to target a particular customer with offers of additional merchandise or services.

Stated with somewhat greater particularity, customer identification according to the preferred embodiments of the present invention is obtained from sources such as, but not limited to, driver's licenses, credit cards, debit cards, American Bankers Association (ABA) routing numbers on checks, or customer frequent buyer club IDs. Such information often is inputted into the POS terminal to complete a customer transaction. The identification information may be manually entered using a keypad or scanned electronically using techniques such as, but not limited to, magnetic strip tracks on cards, optically-read bar codes, magnetic ink character recognition (MICR) numbers on checks, wireless radio frequency ID (RFID) signals, and other suitable methods known in the art. In addition, customers' portable electronic terminal devices, such as but not limited to, cell phones, personal digital assistants (PDAs), pagers, and/or MP3 players could provide identification and/or billing numbers to a merchant's point-of-sale terminals through physical wired interfaces as well as wireless or even optical interfaces, which display bar codes on the display of a customer terminal (cell phone, PDA, pager, MP3 player) that are scanned by bar code readers at the point of sale. Also, customers may be identified biometrically using techniques such as, but not limited to, fingerprints, voice spectral analysis, facial structure recognition, etc.

Information relating to a current purchase is supplied to the database for updating the transaction profile associated with that particular customer. Based on information in that profile and on the nature of the current purchase, the process may suggest one or more additional goods or services of likely interest to the customer. These suggestions may be presented to the customer at the POS terminal, for example, on the credit/debit card receipt or other transaction receipt printed for the customer at the terminal, or on a visual display generated at the terminal for the customer.

Other advantages and objects of the present invention will become more apparent from the following description of a preferred embodiment.

### BRIEF DESCRIPTION OF THE DRAWINGS

FIG. 1 shows apparatus for practicing a disclosed embodiment of the present invention.

FIG. 2 illustrates logical steps of a process according to the disclosed embodiment.

FIG. 3 is a pictorial representation of exemplary customer and transaction data according to a disclosed embodiment.

FIG. 4 illustrates process steps according to the disclosed embodiment.

### DETAILED DESCRIPTION OF DISCLOSED EMBODIMENT

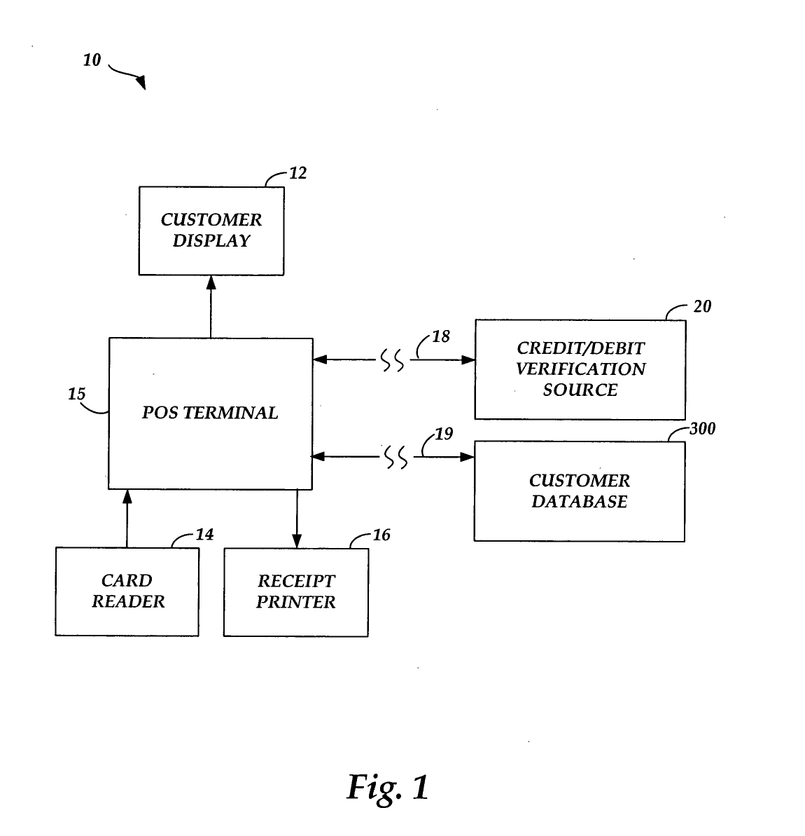

FIG. 1 shows generally at 10 a point-of-sale (POS) terminal apparatus including a POS terminal 15 used in conjunction with a disclosed embodiment of the present invention. It will be evident from the following discussion that the POS terminal 15 in the disclosed embodiment is located at a retail establishment dealing in consumer electronics goods and related services. However, it should be understood that the specific goods and services described with respect to and offer for sale at the location of the POS terminal 15 is only by way of example and is not limiting of the present invention.

A typical POS terminal 15 will include a keyboard for entering amounts and other particulars of a sales transaction, a visible display 12 on which details of a current transaction are displayed for view by a terminal operator and the customer, a card reader 14 for electronic reading of identification such as credit or debit cards presented by customers, and a receipt printer 16 for printing receipts confirming customer transactions and debit/credit confirmations for those transactions. A typical POS terminal 15 also includes a cash drawer for receiving cash transactions and may include a bar-code scanner for reading product bar codes on merchandise presented by customers at the POS terminal. The nature and operation of POS terminals and related peripheral equipment are known to those skilled in the art and need not be discussed herein in greater detail.

A typical POS terminal 15 also includes a data link 18 to a credit card, debit card, and/or check verification source 20. In a typical non-cash retail sales transaction, the customer's debit card or credit card is scanned by the card reader 14 to detect customer information encoded as track data on a magnetic strip or other data storage element associated with the card. The POS terminal 15 transmits the customer's identification number (ID) to the verification source 20 in a manner known to those skilled in the art, and completes the customer transaction in response to approval or verification returned to the terminal from the verification source. In response to that approval, the POS terminal usually drives the printer 16 to print a paper receipt showing details of each item or service purchased during the transaction. The printed receipt also may include the date and time of the transaction, identification information for the merchant, identification information for the POS terminal, an authorization code from the credit/debit card or check verification service, the amount of any applicable tax, and the total amount of the transaction charged or debited to the customer's account.

A process according to the disclosed embodiment of the present invention seeks to present customers with offers of additional goods and/or services contemporaneously in time with a current transaction and while the customer is still in reasonable proximity to the POS terminal and/or merchant's store. As a non-limiting example, a customer may receive an offer for additional goods and/or services from a first merchant while completing the transaction at the first merchant's POS terminal, while still within the first merchant's store, or while still within the same shopping complex or parking lot of the first merchant. As another non-limiting example, a customer may receive an offer from a second merchant as a result of a purchase of a good or service at a first merchant while the customer is still shopping at the same shopping mall or strip mall complex comprising the first and second merchants.

In some non-limiting embodiments, the offer for additional goods and/or services may be based on a current transaction and/or on a history of available previous transactions for the individual customer. These offers are generated and presented to the customer contemporaneously with the current transaction such that the customer is likely to still be in proximity to the point-of-sale (POS) terminal, still within the store of the transaction, still in the same complex of merchants such as a shopping mall or strip mall, or still within the associated parking lot.

Furthermore, the offer can be presented to the customer through various non-limiting media and/or terminals. For instance, the offer could be presented in paper on the customer's transaction receipt from the POS terminal. Also, the offer could be presented as a separate printed piece of paper that is output from the POS terminal. In addition, the offer could be shown electronically on the merchant's POS terminal. Alternatively, the offer could be delivered electronically to a customer's own terminal equipment including electronic devices such as, but not limited to, cell phones, PDAs, pagers, MP3 players, etc. The offer for additional goods and/or services may be provided as part of electronic receipt information that is transferred from the merchant to a customer's portable electronic device/terminal (e.g., cell phone, PDA, pager, MP3 player, etc.). Such electronic receipts may allow consumers to easily upload transaction records into personal accounting and budgeting systems such as Quicken or Microsoft Money. Also, the offer may be communicated electronically to a customer's portable electronic device in a manner that is separate from and independent of the transfer of a transaction receipt to the customer in electronic and/or paper format.

The offer is generated according to the disclosed preferred embodiment by gathering information regarding past purchases by customers and classifying those purchases into categories deemed relevant as predictors of possible future purchasing interest. The process thus seeks to identify recognizable kinds of customers and to present those customers, contemporaneously to a current transaction, with offers of other goods or services of possible interest to that customer.

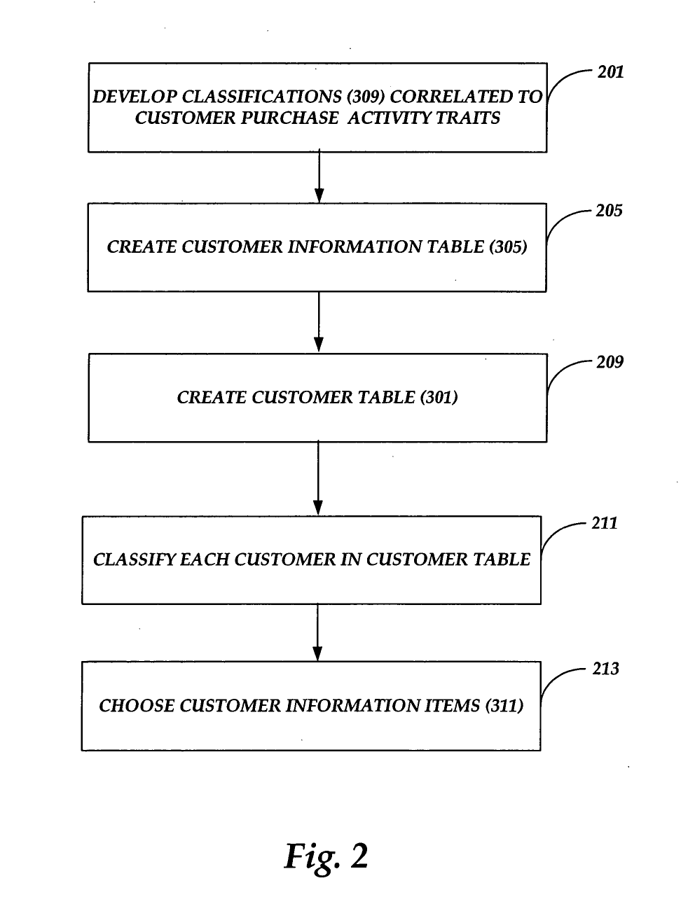

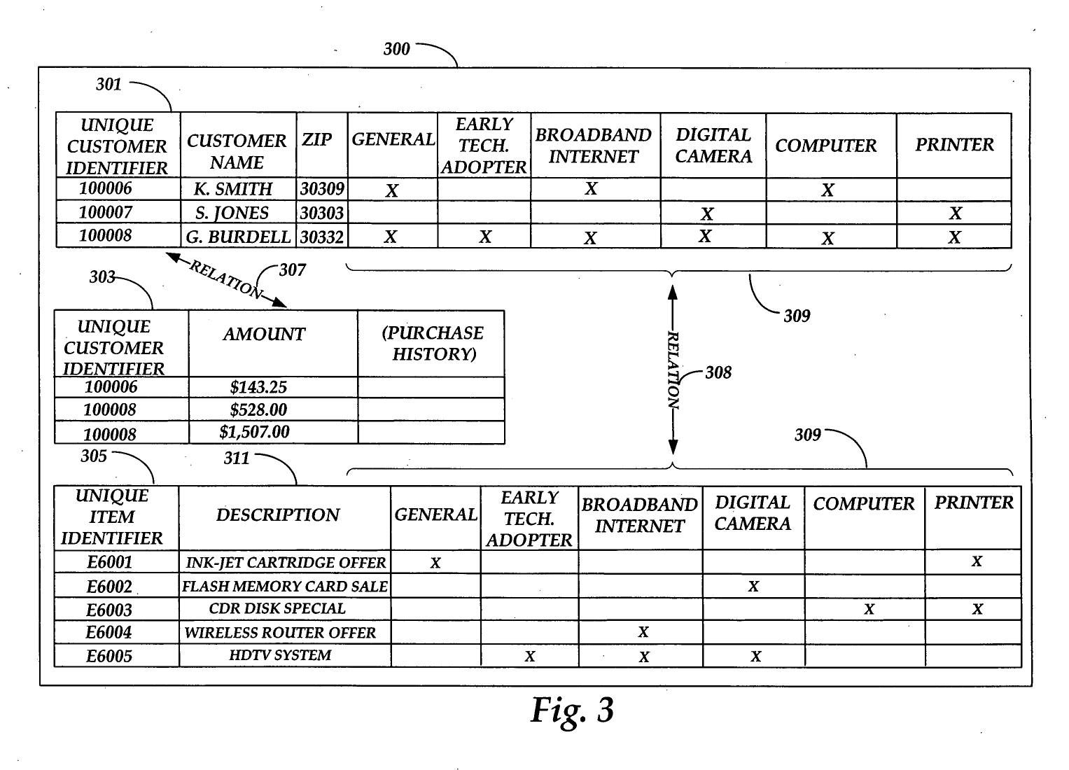

FIG. 2 shows a flow chart depicting a method in accordance with an embodiment of the invention for collecting information on customer transactions and classifications relating to those transactions. For illustrative purposes, the method is discussed in the context of a simplified example with reference to FIGS. 3, 4, and 5, and with the embodiment depicted in FIG. 1. It will be understood by those skilled in the art that the disclosed embodiment is but one of various ways in which the present invention may be practiced.

Some actions of the present method are taken by an operator. Such an operator may be a merchandiser or an agent of the merchandiser, or may be a supplier of services to one or more users such as merchandisers or others involved with selling goods or services to customers. Also, the operator may be a credit card/debit card processor or check verifier that maintains records of a customer's categories of transactions across a plurality of merchants. Referring to FIG. 2, at 201 an operator develops a set of classifications correlated to customer purchase activity traits. For example, the classifications may include goods and services available from a merchandiser or other vendor. Those classifications may be developed based only or primarily on customers of a particular vendor, e.g., a retailer of consumer electronics in the disclosed exemplary embodiment, or may be based on purchase histories of customers from a variety of vendors or other circumstances. For example, the classifications developed at 201 may include equipment and services available from the vendor as described below, and may also include characteristics about the customer, such as the zip code of the customer. The resulting classifications are used to determine whether a particular customer, making a particular purchase and fitting at least one classification, is deemed likely to purchase additional goods or services correlating to that classification. The development of classifications correlated to customer traits may be accomplished by employing standard data mining and statistical correlation techniques. In the context of the present embodiment, customer data is usually based on past commercial transactions and is obtained from past uses of credit or debit cards or other identification presented by the customer. In addition, data mining examination of prior sales data may reveal a trend among some customers to purchase new technologies early in product cycles. This may result in an “early technology adopter” classification for the customer.

FIG. 3 is a pictorial representation of a relational database 300 as may be created in accordance with the method described in FIG. 2. This database 300 comprises three database tables: a customer table 301, a customer purchase activity table 303, and an information table 305. Fields and records define the structure of database tables, as is known to those skilled in the art. The database 300 and the database tables contained therein are created for this example in accordance with the disclosed embodiment of the present invention.

The customer table 301 contains information about customers and has fields such as “Customer Name” and “Customer Zip” (the Zip code for the particular customer). Each record in the customer table 301 thus is a profile of a particular customer, as typically derived from past credit/debit card activity and/or other purchase information associated with that customer. Each record in the customer table also has a unique entry in the field “Unique Customer Identifier”. The customer identifier numbers may comprise credit/debit card numbers for the customers, or in the alternative may comprise arbitrary numbers unique to each customer but not identifying any charge/debit card number for the customer so as to enhance security and privacy by excluding such sensitive information from the database 300.

The customer table 301 also has fields 309 representing the classifications developed in step 201, as described below. In the disclosed example, if a customer is associated with a classification, an “x” appears in the field associated with the particular classification in that customer's record. For example, in the customer table 301, customer K. Smith (unique customer identifier 100006) is associated with two classifications: “general” and “broadband Internet”.

The customer purchase activity table 303 contains information about the purchase history of each customer in the database 300. Thus, the purchase activity table 303 has fields corresponding to the unique customer identifier, and one or more fields collectively identified in FIG. 3 as “Purchase History”. The field or fields making up the purchase history for each purchase activity may include dates and amounts of purchases, the kinds or categories of goods/services purchased, location of the transaction, and other information relevant to classifying the customers in the classification fields 309 of the customer table 301. Each activity record for a particular customer in the customer purchase activity table 303 thus provides data for creating a profile of the purchase activity for that particular customer, based on the purchase history for that customer and usable to classify customers according to the fields 309 in the customer table 301.

Information table 305 in the disclosed embodiment has the same classification fields 309 as the customer table 301, those fields representing the classifications developed in step 201. In addition, the information table 305 includes at least one field 311 of items for possible interest to customers matching one or more of the classification fields. For example, the first item in the description field 311 (unique item identifier E6001) is “Ink-Jet Cartridge Offer”, the second item in that field is “Flash Memory Card Sale”, and so on. In this example, if an item of potential customer interest is associated with a classification field 309, an “x” appears in the field associated with that particular classification. As a further example, the Ink-Jet Cartridge Offer is shown related to the General field and the Printer field in 309. This relationship between items in the description field 11 and classifications in the fields 309 is not a one-to-one relationship; both customers and item descriptions may be associated with more than one classification.

Referring again to FIG. 2, the operator at 205 creates a customer information table. A typical customer information table appears at 305 in FIG. 3 and represents classifications of customers the operator deems applicable to each item for the field 311 in that table. The classification of customers is shown at block 211 in FIG. 2.

The operator also develops the customer table 301 previously described and shown in FIG. 3, at block 209. The customer information (customer name, zip code and assigned unique customer identifier, in the disclosed example) may be developed over time and based on sales activity associated with customers, or alternatively may comprise customer information from other sources such as credit/debit card issuers and other sources of such information. As mentioned above, applicable classifications 309 shown in the table 301 are assigned to each customer at table 305. The result comprises the customer database 300, shown in FIG. 1 as communicating with the POS terminal 15 over a data link 19. The customer database 300 is maintained on a computer-based file server of any appropriate kind. That file server may be operated and maintained by a particular vendor for that vendor's customers, or may alternatively be provided and maintained by a third-party service bureau for use by one or more vendors.

At 213 an operator chooses non-billing information items to communicate with customers. (These information items appear at 311 in the information table 305 of FIG. 3.) For example, customer information items may represent goods and/or services the operator believes may interest customers based on the current and past history of purchases for particular customers, and thus representing sales/purchase opportunities the operator desires to present to customers at the point of sale for other goods or services.

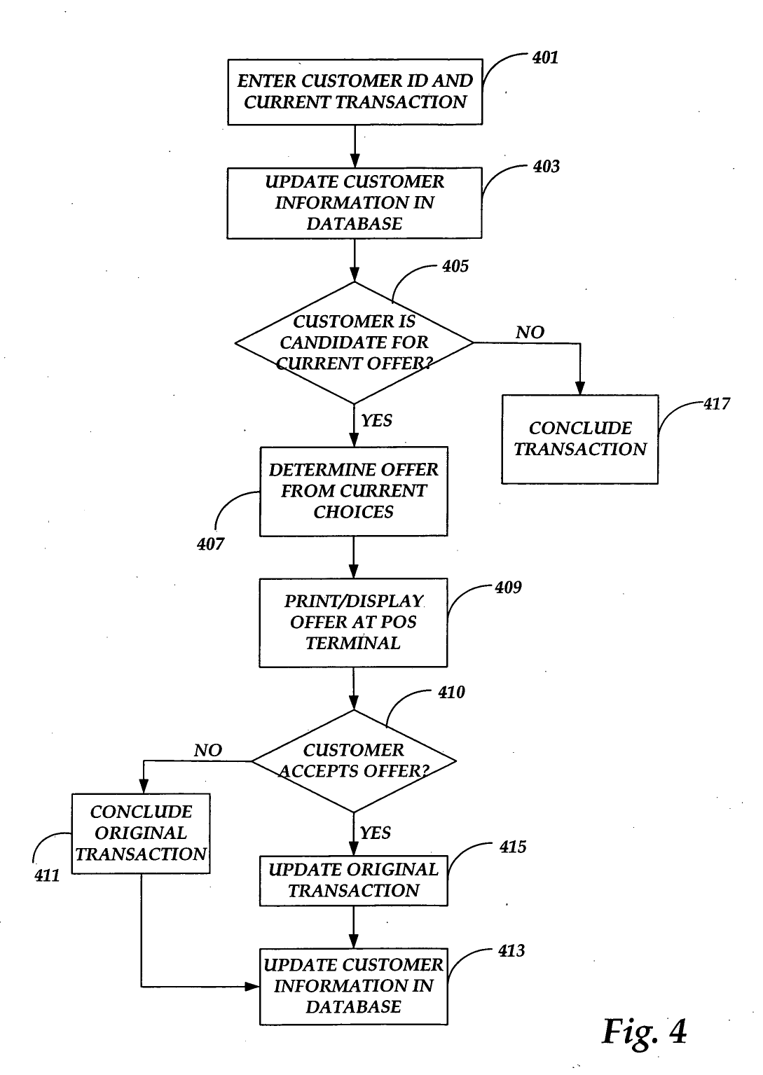

FIG. 4 is a flow chart illustrating an application of the customer database 300 to provide customers with offer information according to the disclosed embodiment. The process begins at 401 by entering customer identification and a current transaction for that customer. Referring back to FIG. 1, the customer identification in the present example may be obtained from the customer's credit or debit card when presented to the card reader 14 associated with the POS terminal 15. Information about the current transaction for that customer is also obtained at the POS terminal 15 as those current purchases are entered, for example, by scanning bar codes associated with the transaction items or by direct key entry at the POS terminal. That customer identification and current-transaction information are sent to the customer database 300 via the data link 19, whereat the customer purchase activity information in the Customer database is updated with particulars of the current transaction as shown at block 403 in FIG. 4.

The process now decides whether the customer is a candidate for offering one or more customer-information items 311, in the information table 305 (FIG. 3), at the time of the current transaction. This determination appears at 405 in FIG. 4 and is based on the classification fields 309 previously assigned to that customer in the customer table 301. For example, customer initial S. Jones is classified in the categories “digital camera” and “printer” in customer table 301. Using a relation 308 between the customer table 301 and the information table 305, the process and system determines that an ink-jet cartridge offer and a flash memory card sale might interest this particular customer. That determination appears at 407 in FIG. 4 and is returned from the customer database 300 to the POS terminal 15 along the data link 19, where the information is printed on the transaction receipt by the printer 16 or displayed at the display 12 associated with the POS terminal, or both, as shown at 409 in FIG. 4.

The customer at 410 now decides whether to accept or reject the offers presented at the POS terminal 15 or using the customer's own portable electronic device as a terminal. If the customer declines any offer presented at the POS terminal (or on the customer's own portable electronic device), the original transaction is concluded at 411, and the customer's refusal of those offers may be used at 413 to update the customer database. However, if the customer accepts either offer, that acceptance is entered at the POS terminal 15 which updates the original transaction at 415 and updates the information in the customer database 300 to reflect acceptance of the POS offer.

Reverting to decision block 405 in FIG. 4, if the customer is not considered a candidate for a current offer, the POS terminal 15 concludes the transaction at that point as indicated at 417. However, information related to the current transaction, entered at 403 in FIG. 4, may remain in the customer database 300 to provide historical bases for evaluating offers for future transactions by that customer.

It should be apparent that the foregoing relates only to a disclosed embodiment of the present invention and that numerous changes and modifications thereto may be made without departing from the sprit and scope of the invention as set forth in the following claims.

What is claimed is:

1. A method of providing targeted information to a customer, the method comprising the steps of:
receiving an indication from a customer of the customer's desire to purchase at least one customer-selected item at a first store, the indication being communicated from the customer contemporaneously with the customer being in proximity of the first store;
obtaining information about at least one additional item that is associated with purchasing behavior of the customer, the at least one additional item based upon the customer's desire to purchase the at least one customer-selected item at least partially inferring the purchasing behavior of the customer; and
conveying the information to the customer about the at least one additional item that is related to the customer's inferred purchasing behavior, the information being conveyed to the customer while the customer is in proximity to the store.

2. The method of claim 1, wherein inferring purchasing behavior of the customer is further based at least upon historical information on previous purchases of the customer.

3. The method of claim 1, wherein inferring purchasing behavior of the customer is further based at least upon historical information on previous purchases of at least one other customer with characteristics similar to the customer.

4. The method of claim 3, wherein the similar characteristics comprise at least one demographic parameter.

5. The method of claim 1, wherein the indication of the customer's desire to purchase the at least one customer-selected item at the first store is indicated through the customer's physical claiming of the at least one item from inventory of the first store by placing the at least one item in a shopping basket container.

6. The method of claim 5, wherein the shopping basket container uses RFID tags to determine that the customer has physically claimed the at least one item by placing the at least one item in the shopping basket container.

7. The method of claim 6, wherein the shopping basket container uses wireless electromagnetic communication to provide the indication of the customer's desire to purchase the at least one item.

8. The method of claim 1, wherein the indication of the customer's desire to purchase the at least one customer-selected item is communicated through a point-of-sale device at the first store.

9. The method of claim 1, wherein the information about the at least one additional item is communicated to the customer through a point-of-sale device at the first store.

10. The method of claim 1, wherein the customer is considered to be in proximity to the first store responsive to the customer being at a point-of-sale device of the first store.

11. The method of claim 1, wherein the customer is considered to be in proximity to the first store responsive to the customer being inside the first store.

12. The method of claim 1, wherein the customer is considered to be in proximity to the first store responsive to the customer being in a parking lot supporting the first store.

13. The method of claim 1, wherein the customer is considered to be in proximity to the first store responsive to the customer being at a shopping mall or shopping center comprising the first store.

14. The method of claim 13, wherein the customer is considered to be in proximity to the first store responsive to the customer being in a second store in that is part of the shopping mall or shopping center comprising the first store.

15. The method of claim 14, wherein inferring purchasing behavior of the customer is further based at least upon historical information on previous purchases of the customer at the second store.

16. A method for providing targeted information to a customer at a point-of-sale, comprising:
receiving a request from the point-of-sale for targeted information associated with the customer, the request comprising customer identification information and point-of-sale purchase information;
updating purchase information located in a customer profile database with the point-of-sale purchase information;
determining whether targeted information in the form of personalized non-billing information should be provided to the customer at the point-of-sale;
if targeted information should be provided, retrieving targeted information correlated to the updated purchase information in the customer profile database; and
sending the targeted information to the point-of-sale.

17. The method of claim 16, further comprising printing the personalized non-billing information on a customer receipt.

18. The method of claim 16, wherein determining whether personalized non-billing information should be provided to the customer at the point-of-sale comprises
developing classifications of purchasing interest for goods or services correlated to buying traits of customers; and
determining whether a current purchase by the customer fits at least one such classification, indicating that the customer is likely to purchase additional goods or services correlated to the at least one classification.

19. The method of claim 16, wherein the customer profile database comprises:
a customer identifier;
a purchase history comprising a date and location of a purchase, product or service identifiers corresponding to each purchase, date and location of each purchase, and amount paid for each purchase; and
a set of classifications that correlate to customer purchase habits derived from the purchase history; and wherein
determining whether targeted information should be provided to the customer at the point-of-sale comprises comparing the customer's purchase history to a set of threshold values corresponding to the set of classifications.

20. A system for communicating with a customer at a point of sale, comprising:
a processor in communication with the terminal at the point of sale;
a data store operatively associated with the processor and comprising a customer table containing customer identification information and a purchase history for each identified customer;
the data store further comprising a set of classifications that correlate to customer purchase habits derived from the purchase histories; and
the processor is operative in response to information received from the terminal identifying a particular customer and a current purchase by the particular customer to determine, from the received information and the set of classifications, whether targeted information in the form of personalized non-billing information should be provided to the particular customer and, if so, to send the targeted information to the terminal for presenting to the customer.
